(19) United States
(12) Patent Application Publication
(10) Pub. No.: US 2006/0131870 A1
(43) Pub. Date: Jun. 22, 2006

(54) Exhaust pulse control unit and method

(76) Inventors: Graham P. Bush, Troy, MI (US); Jason M. Kolk, Waterford, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/313,840

(22) Filed: Dec. 20, 2005

Related U.S. Application Data
(60) Provisional application No. 60/638,550, filed on Dec. 22, 2004.

(51) Int. Cl. F16L 11/12

(52) U.S. Cl. 285/49

(57) ABSTRACT

An exhaust pulse control unit and related method comprise an inlet tube communicating with incoming exhaust gas, an outlet tube communicating with exiting exhaust gas, and a housing extending between and connected with the inlet tube and outlet tube at opposite ends thereof. At least one pulse capture and expansion zone is disposed between the inlet tube and an intermediate zone portion of the housing, and is configured to increase exhaust manifold vacuum in an associated internal combustion engine. A first connector flange, having an attachment portion and central aperture, is connected with an inlet end of the housing. A second connector flange, having an attachment portion aligned with the attachment portion of the first flange and a central aperture, is connected with the inlet tube. The central aperture of the second flange has a beveled surface formed integrally therein to define a nozzle which forms the pulse capture and expansion zone. A fastener detachably, yet securely, connects the attachment portions of the first and second flanges to form an airtight seal between the inlet tube and the housing.

### CLAIM OF PRIORITY

Applicants hereby claim priority benefits under the provisional of 35 U.S.C. § 119, basing said claim of priority to Provisional Patent Application Ser. No. 60/638,550, filed Dec. 22, 2004.

### BACKGROUND OF THE INVENTION

The present invention relates to engine exhaust pulse control units for motor vehicles and the like, and in particular to an integrated nozzle/connector and method therefor.

Exhaust pulse control units, such as that disclosed in U.S. Patent Publication 2003/0159437 to Oberhardt, are known in the art, and are designed to control the expansion of exhaust gases from an internal combustion engine to improve engine power and efficiency. In the referenced Oberhardt patent document, the exhaust pulse control unit has an intermediate zone which extends between inlet and outlet tubes. A first exhaust pulse capture and expansion zone is integrally formed in the trailing end of the inlet tube, and a second exhaust pulse capture and expansion zone is integrally formed in the leading end of the intermediate zone or housing. A merging zone is integrally formed in the leading end of the outlet tube and mates with the interior of the intermediate zone or housing to create negative pressure exhaust pulses upstream of the exhaust pulse control unit for increasing exhaust manifold vacuum in the engine to improve performance and efficiency. The size and shape of the exhaust pulse capture and expansion zones, as well as the merging zone, are important to achieve proper tuning with the engine. Hence, the formation of the associated surfaces, and their interconnection, must be carefully controlled to achieve proper operation of the exhaust pulse control unit.

### SUMMARY OF THE INVENTION

One aspect of the present invention is an exhaust pulse control unit for internal combustion engines, comprising an inlet tube configured for communication with incoming exhaust gas, an outlet tube configured for communication with exiting exhaust gas, and a housing extending between and operably connected with the inlet tube and the outlet tube adjacent opposite ends thereof. An intermediate zone is disposed along a medial portion of the housing. At least one pulse capture and expansion zone is disposed between the inlet tube and the intermediate zone of the housing, and is configured to increase exhaust manifold vacuum in an associated internal combustion engine. A first connector flange, having a radially outwardly extending attachment portion, and a central aperture axially aligned with the housing, is operably connected with the housing. A second connector flange, having a radially outwardly extending attachment portion which is axially aligned with the attachment portion of the first connector flange, and a central aperture which is axially aligned with the inlet tube, and includes an inlet portion and an oppositely disposed outlet portion, is operably connected with the inlet tube adjacent the inlet portion thereof. The outlet portion of the central aperture of the second connector flange has a beveled surface formed integrally therein to define a nozzle which forms the pulse capture and expansion zone. A fastener detachably, yet securely, connects the attachment portion of the first connector flange with the attachment portion of the second connector flange to form an airtight seal between the inlet tube and the housing.

Another aspect of the present invention is a method for making an exhaust pulse control unit for internal combustion engines, comprising forming an inlet tube into a shape configured for communication with incoming exhaust gas, forming an outlet tube into a shape configured for communication with exiting exhaust gas, and forming a housing shaped to extend between the inlet tube and the outlet tube. The method further comprises operably connecting the inlet tube to one end of the housing and the outlet tube to the opposite end of the housing, and forming an intermediate zone along a medial portion of the housing. The method further includes forming a first connector flange having a radially outwardly extending attachment portion and a central aperture therethrough, axially aligning the central aperture of the first connector flange with the housing, and operably connecting the first connector flange with the housing. The method also includes forming a second connector flange having a radially outwardly extending attachment portion and central aperture therethrough which includes an inlet portion and an oppositely disposed outlet portion, axially aligning the central aperture of the second connector flange with the inlet tube, such that the attachment portions of the first and second connector flanges are axially aligned, and operably connecting the second connector flange with the inlet tube, such that the attachment portions of the first and second connector flanges are axially aligned, and operably connecting the second connector flange with the inlet tube adjacent the inlet portion thereof. The method further includes integrally forming at least one beveled surface in the outlet portion of the central aperture of the second connector flange to define a nozzle which forms at least one pulse capture and expansion zone configured to increase exhaust manifold vacuum in an associated internal combustion engine, and detachably, yet securely, fastening the attachment portion of the first connector flange with the attachment portion of the second connector flange to form an airtight seal between the inlet tube and the housing.

Yet another aspect of the present invention is to provide an exhaust pulse control unit having an uncomplicated design with reduced manufacturing costs. The exhaust pulse control unit can be accurately and repeatedly manufactured with improved nozzle surface quality. By removing welding operations from the nozzle areas, more consistent engine tuning can be achieved. The exhaust pulse control unit is efficient in use, capable of a long operating life and particularly well adapted to for the proposed use. These and other advantages of the invention will be further understood and appreciated by those skilled in the art by reference to the following written specification, claims and appended drawings.

### BRIEF DESCRIPTION OF THE DRAWINGS

FIG. 1 is a fragmentary, cross-sectional view of an exhaust pulse control unit embodying the present invention.

FIG. 2 is a fragmentary, cross-sectional view of another embodiment of the present invention.

FIG. 3 is a fragmentary, cross-sectional view of yet another embodiment of the present invention.

FIG. 4 is a fragmentary, cross-sectional view of yet another embodiment of the present invention.

FIG. 5 is a fragmentary, cross-sectional view of yet another embodiment of the present invention.

### DETAILED DESCRIPTION OF THE PREFERRED EMBODIMENTS

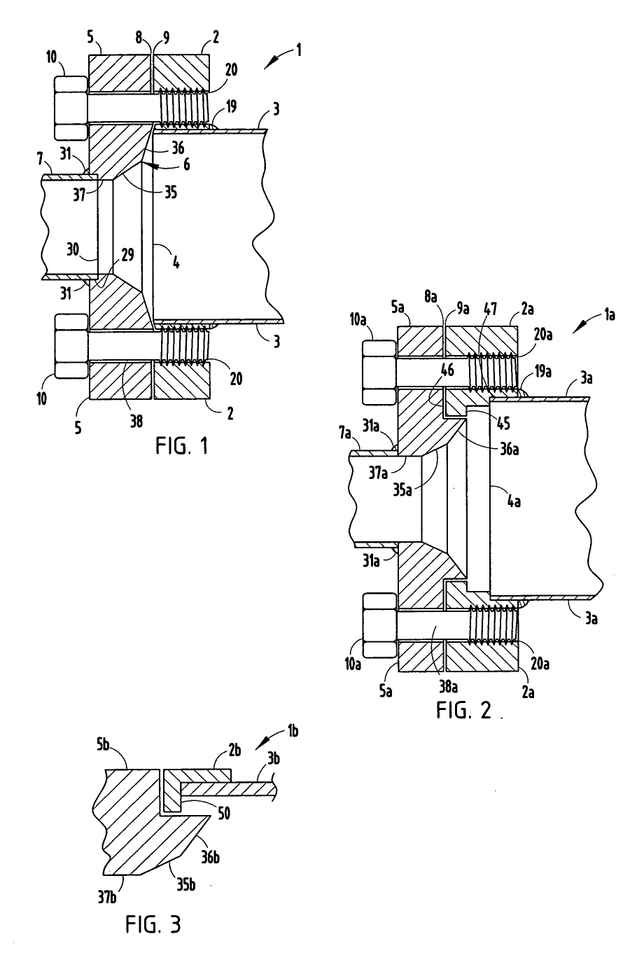

For purposes of description herein, the terms “upper”, “lower”, “right”, “left”, “rear”, “front”, “vertical”, “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 1 (FIG. 1) generally designates an exhaust pulse control unit embodying the present invention. Exhaust pulse control unit 1 includes a first connector flange or collar 2 rigidly attached to a housing portion 3 of exhaust pulse control unit 1 adjacent an inlet end 4 thereof. A second connector flange 5 has at least one pulse capture and expansion zone 6, in the form of a nozzle, integrally formed therein, and is rigidly attached to an inlet tube portion 7 of exhaust pulse control unit 1 adjacent the inlet end 4 of housing 3. Collar 2 and connector flange 5 have mating surfaces 8 and 9, which abut to form an airtight seal therebetween. Fasteners 10 securely, yet detachably, interconnect collar 2 and connector flange 5 in the abutting, sealed condition to create negative pressure exhaust pulses in housing 3, increase exhaust manifold vacuum, and improve engine power and efficiency.

In the illustrated example, collar 2 is in the form of an annularly-shaped disk, having a circular central aperture axially aligned with housing 3, and defined by an inside surface, as well as a circular outside surface, and opposing side faces. The side faces are generally flat and parallel to one another. The inside surface of collar 2 is shaped to be closely received over the outside surface of housing 3. A weld 19 extends about the periphery of the side face adjacent the inside surface of collar 2 to rigidly interconnect collar 2 to housing 3, and form a substantially airtight seal therebetween. Collar 2 includes a radially outwardly extending attachment portion, with a plurality of axially extending, threaded apertures 20, which are spaced circumferentially about collar 2 in a predetermined pattern.

The illustrated connector flange 5 is also generally annular in shape, and includes a circular central aperture axially aligned with housing 3 and defined by an inside surface, as well as a circular outside surface, and opposite side faces. The side faces are generally flat and parallel to one another. The outside surface of connector flange 5 is sized to mate with the outside surface of collar 2. The inside surface of connector flange 5 includes an inlet portion with stepped portion 29 configured to closely receive the trailing end 30 of inlet tube 7 therein. A weld 31 extends around the circumference of inlet tube 7 adjacent end 30 to rigidly attach connector flange 5 to inlet tube 7 and form a substantially airtight seal therebetween.

In the illustrated example, the interior or outlet side face of connector flange 5 includes two exhaust pulse capture and expansion zones 35 and 36 formed integrally therein. A circular lip 37 is formed in the side face of connector flange 5 adjacent end 30 of inlet tube 7. Exhaust pulse capture and expansion zone 35 is defined by an integrally formed beveled or angled surface adjacent lip 37, and exhaust pulse capture and expansion zone 36 is formed adjacent or adjoining zone 35 by an integrally formed beveled or angled surface, and tapers to the inner face between the side face of connector flange 5 and the side face of collar 2. Since collar 2 and connector flange 5 are fabricated as separate parts, the sizes and shapes of the exhaust pulse capture and expansion zones 35 and 36, as well as lip 37, can be formed precisely by means such as grinding or the like at relatively low cost. In the example shown in FIG. 1, beveled surface 36 is disposed at an angle substantially greater than the angle of beveled surface 35. Connector flange 5 also includes a radially outwardly extending attachment portion, with a plurality of axially extending apertures 38 disposed about the circumference thereof, which are aligned with the apertures 20 in collar 2 to receive threaded fasteners 10 therethrough. Apertures 38 are preferably not threaded.

The illustrated housing 3 is cylindrical in shape, and includes an intermediate zone disposed along a medial portion thereof, which is configured to cooperate with the pulse capture and expansion zone 6 to increase exhaust manifold vacuum.

In the illustrated example, collar 2 and connector flange 5 are constructed from hardened steel, and formed using known manufacturing techniques, such as machining, casting, powdered metal forming, and the like. Collar 2 is positioned on housing 3 and connected therewith by welding in the manner described above. Connector flange 5 is positioned on inlet tube 7 and welded thereto in the manner described above. A plurality of bolts 10, or other similar fasteners, are inserted through apertures 38 in connector flange 5 and threadedly engaged in the threaded apertures 20 on collar 2 to securely, yet detachably, draw the adjacent faces 8 and 9 into close sealing contact to define a substantially airtight seal therebetween.

It is to be understood that connector flange 5 may be formed using a variety of alternative processes, such as machining wrought steel, molded in powdered metal, spin formed, ram formed, deep drawn, or the like. The specific process selected will depend upon quantity of production, tool cost, geometric precision, and other similar factors.

The reference numeral 1a (FIG. 2) generally designates another embodiment of the present invention, having a step 45 formed in the inside surface of collar 2a and a mating land 46 formed in the interior face of connector flange 5a. Since exhaust pulse control unit 1a is similar to the previously described exhaust pulse control unit 1, similar parts appearing in FIGS. 1 and 2 respectively are represented by the same, corresponding reference numerals, except for the suffix “a” in the numerals of the latter. In the illustrated example, step 45 has a generally L-shaped side elevational cross-sectional configuration, and includes a groove 47 in which the end 4a of housing 3a is closely received, with weld 19a extending therebetween.

The reference numeral 1b (FIG. 3) generally designates yet another embodiment of the present invention, having an indented step 50 on the inside surface of collar 2b. Since exhaust pulse control unit 1b is similar to the previously described exhaust pulse control units 1 and 1a, similar parts appearing in FIGS. 1-2 and 3 respectively are represented by the same, corresponding reference numerals, except for the suffix “b” in the numerals of the latter. In the illustrated example, indented step 50 has a generally L-shaped side elevational cross-sectional configuration, wherein the inlet end of housing 3b is closely received against the inside surface of collar 2b. The indented step design shown in FIG. 3 can be used on the band clamp embodiment shown in FIG. 4, and discussed below, as well as the embodiments shown in FIGS. 1 and 2.

The reference numeral 1c (FIG. 4) generally designates yet another embodiment of the present invention, having a band clamp 55 to detachably interconnect collar 2c and connector flange 5c. Since exhaust pulse control unit 1c is similar to the previously described exhaust pulse control units 1, 1a and 1b, similar parts appearing in FIGS. 1-3 and FIG. 4 respectively are represented by the same, corresponding reference numerals, except for the suffix “c” in the numerals of the latter. In the illustrated exhaust pulse control unit 1c, the outside surface of collar 2c and the outside surface of connector flange 5c are both tapered in opposite directions to form a V-shaped or wedge-like exterior. Band clamp 55 has a similar V-shaped or wedged configuration which mates with the outside surfaces of collar 2c and connector flange 5c, and extends about the circumference thereof. Band clamp 55 may be split, with a threaded connector 56 interconnecting the opposite ends thereof in a manner which permits band clamp 55 to be securely, yet detachably, tightened in place in a constricting manner about collar 2c and connector flange 5c.

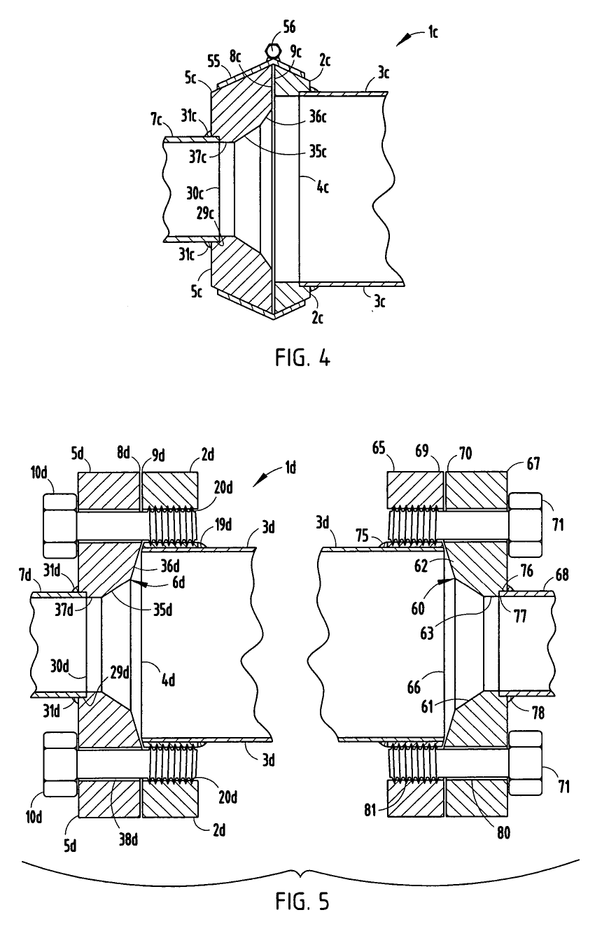

The reference numeral 1d (FIG. 5) generally designates yet another embodiment of the present invention, having a merger zone 60 located at the outlet end of the associated exhaust pulse control unit 1d. Since exhaust pulse control unit 1d is similar to the previously described exhaust pulse control unit 1, similar parts appearing in FIGS. 1 and 5 respectively are represented by the same, corresponding reference numerals, except for the suffix “d” in the numerals of the latter. In the illustrated exhaust pulse control unit 1d, the inlet side thereof is identical to that disclosed in FIG. 1, which includes a first connector flange or collar 2d rigidly attached to a housing portion 3d of exhaust pulse control unit 1d adjacent the inlet end 4d thereof. A second connector flange 5d has at least one pulse capture and expansion zone 6, in the form of a nozzle, integrally formed therein, and is rigidly attached to an inlet tube portion 7d of exhaust pulse control unit 1d adjacent the inlet end 4d of housing 3d. Collar 2d and connector flange 5d have mating surfaces 8d and 9d, which abut to form an airtight seal therebetween. Fasteners 10d securely, yet detachably, interconnect collar 2d and connector flange 5d in the abutting, sealed condition to create negative pressure exhaust pulses in housing 3d, increase exhaust manifold vacuum, and improve engine power and efficiency.

Exhaust pulse control unit 1d also includes a third connector flange or collar 65 rigidly attached to the housing portion 3d of exhaust pulse control unit 1d adjacent an outlet end 66 thereof. A fourth connector flange 67 has merger zone 60, in the form of a nozzle, integrally formed therein, and is rigidly attached to an outlet tube portion 68 of exhaust pulse control unit 1d adjacent the outlet end 66 of housing 3d. Collar 65 and connector flange 67 have mating surfaces 69 and 70, which abut to form an airtight seal therebetween. Fasteners 71 securely, yet detachably, interconnect collar 65 and connector flange 67 in the abutting, sealed condition to create negative pressure exhaust pulse gases in housing 3d, increase exhaust manifold vacuum, and improve engine power and efficiency.

In the illustrated example, collar 65 is substantially identical in construction to collar 2d, and connector flange 67 is substantially identical to connector flange 5d, except that both are located at the outlet end of housing 3d. The inside surface of collar 65 is shaped to be closely received over the outside surface of housing 3d, at the end thereof opposite collar 2d. A weld 75 extends about the periphery of the side face adjacent the inside surface of collar 65 to rigidly interconnect collar 65 to housing 3d, and form a substantially airtight seal therebetween. The outside surface of connector flange 67 is sized to mate with the outside surface of collar 65. The inside surface of connector flange 67 includes an outlet portion with a stepped portion 76 configured to closely receive the leading end 77 of outlet tube 68 therein. A weld 78 extends around the circumference of outlet tube 68 adjacent the stepped portion 76 of connector flange 67 to rigidly attach connector flange 67 to outlet tube 68 and form a substantially airtight seal therebetween.

In the illustrated example, the inlet side face of connector flange 67 includes two merger zones 61 and 62 formed integrally therein in a concentric relationship with the central aperture or lip 63. Merger zone 61 is defined by an integrally formed beveled or angled surface adjacent lip 63, and merger zone 62 is formed adjacent or adjoining merger zone 61 by an integrally formed beveled or angled surface, and tapers to the interface between the side face 70 of connector flange 67 and the side face 69 of collar 65. Since collar 65 and connector flange 67 are fabricated as separate parts, as are collar 2d and connector flange 5d, the sizes and shapes of the merger zones 61 and 62, as well as lip 63, can be formed precisely by means such as grinding or the like at relatively low cost. Connector flange 67 also includes a radially outwardly extending attachment portion, with a plurality of axially extending apertures 80 disposed about the circumference thereof, which are aligned with the apertures 81 in collar 65 to receive threaded fasteners 71 therethrough. The tightening of threaded fasteners 71 draws collar 65 and connector flange 67 closely together to create an airtight seal between outlet tube 68 and housing 3d.

In each example, the formation of the exhaust pulse capture and expansion zones 35 and 36, merger zones 61 and 62, as well as lips 37 and 63, in the separate connector flanges, which are detachably connected by fasteners to an associated collar, permits forming critical dimensions into hard surfaces with the dimensional tolerances closer than that possible in prior art exhaust pulse control units. The associated method provides accurate and repeatable manufacturing of exhaust pulse control units in an economical manner. Since the surfaces forming exhaust pulse capture and expansion zones 35 and 36 and merger zones 61 and 62, as well as lips 37 and 63, are critical to performance, the present design provides a greatly improved design. By forming critical dimensions into a hard connector flange, the tolerances can be held much closer than possible when forming the nozzle from tubing.

In the foregoing description, it will be readily appreciated by those skilled in the art that modifications may be made to the invention without departing from the concepts disclosed herein.

The invention claimed is as follows.

1. An exhaust pulse control unit for internal combustion engines, comprising:
an inlet tube configured for communication with incoming exhaust gas;
an outlet tube configured for communication with exiting exhaust gas;
a housing extending between and operably connected with said inlet tube and said outlet tube adjacent opposite ends thereof;
an intermediate zone disposed along a medial portion of said housing;
at least one pulse capture and expansion zone disposed between said inlet tube and said intermediate zone of said housing, and configured to increase exhaust manifold vacuum in an associated internal combustion engine;
a first connector flange having a radially outwardly extending attachment portion, and a central aperture therethrough which is axially aligned with said housing; said first connector flange being operably connected with said housing;
a second connector flange having a radially outwardly extending attachment portion which is axially aligned with said attachment portion of said first connector flange, and a central aperture therethrough which is axially aligned with said inlet tube, and includes an inlet portion and an oppositely disposed outlet portion; said second connector flange being operably connected with said inlet tube adjacent said inlet portion thereof; said outlet portion of said central aperture of said second connector flange having a beveled surface formed integrally therein to define a nozzle which forms said pulse capture and expansion zone; and
a fastener detachably, yet securely, connecting said attachment portion of said first connector flange with said attachment portion of said second connector flange to form an airtight seal between said inlet tube and said housing.

2. An exhaust pulse control unit as set forth in claim 1, wherein:
said beveled surface of said second connector flange defines a first beveled surface; and
said outlet portion of said central aperture of said second connector flange includes a second beveled surface integrally formed therein and configured to increase exhaust manifold vacuum in the associated internal combustion engine.

3. An exhaust pulse control unit as set forth in claim 2, wherein:
said first beveled surface is configured at an angle different from the angle of said second beveled surface.

4. An exhaust pulse control unit as set forth in claim 3, wherein:
said first beveled surface adjoins said second beveled surface.

5. An exhaust pulse control unit as set forth in claim 4, wherein:
said second beveled surface is disposed at an angle greater than the angle of said first beveled surface.

6. An exhaust pulse control unit as set forth in claim 5, wherein:
said second connector flange is constructed from hardened steel, and said first and second beveled surfaces are ground precisely therein.

7. An exhaust pulse control unit as set forth in claim 6, wherein:
said fastener comprises a plurality of threaded fasteners extending through and retained in mating axially extending fastener apertures in said attachment portions of said first and second attachment flanges, such that tightening of said threaded fasteners draws said first and second connector flanges closely together to create said airtight seal between said inlet tube and said housing.

8. An exhaust pulse control unit as set forth in claim 7, wherein:
said second connector flange includes a generally L-shaped annular step disposed adjacent to said housing; and
said first connector flange includes a generally L-shaped annular ring portion disposed adjacent to said inlet tube, and configured for close reception in said annular step in said second connector flange.

9. An exhaust pulse control unit as set forth in claim 6, wherein:
said attachment portions of said first and second attachment flanges include oppositely tapered marginal surfaces; and
said fastener comprises a band clamp having oppositely tapered flange portions thereof which mate with the tapered marginal surfaces of said attachment portions of said first and second connector flanges, such that constriction of said band clamp draws said first and second connector flanges closely together to create said airtight seal between said inlet tube and said housing.

10. An exhaust pulse control unit as set forth in claim 7, including:
a first weld extending between and around said inlet tube and said second connector flange to define an airtight seal therebetween.

11. An exhaust pulse control unit as set forth in claim 10, including:
a second weld extending between and around said housing and said first connector flange to define an airtight seal therebetween.

12. An exhaust pulse control unit as set forth in claim 11, including:
a third connector flange having a radially outwardly extending attachment portion, and a central aperture therethrough which is axially aligned with said housing at an end thereof opposite said first connector flange; said connector flange being operably connected with said housing; and
a fourth connector flange having a radially outwardly extending attachment portion which is axially aligned with said attachment portion of said third connector flange, and a central aperture therethrough which is axially aligned with said outlet tube, and includes an inlet portion and an oppositely disposed outlet portion; said fourth connector flange being operably connected with said outlet tube adjacent said inlet portion thereof; said inlet portion of said central aperture of said fourth connector flange having a beveled surface formed integrally therein to define a merger zone between said housing and said outlet tube.

13. An exhaust pulse control unit as set forth in claim 1, wherein:
said second connector flange is constructed from hardened steel, and said beveled surface is ground precisely therein.

14. An exhaust pulse control unit as set forth in claim 1, wherein:
said fastener comprises a plurality of threaded fasteners extending through and retained in mating axially extending fastener apertures in said attachment portions of said first and second attachment flanges, such that tightening of said threaded fasteners draws said first and second connector flanges closely together to create said airtight seal between said inlet tube and said housing.

15. An exhaust pulse control unit as set forth in claim 1, wherein:
said second connector flange includes a generally L-shaped annular step disposed adjacent to said housing; and
said first connector flange includes a generally L-shaped annular ring portion disposed adjacent to said inlet tube, and configured for close reception in said annular step in said second connector flange.

16. An exhaust pulse control unit as set forth in claim 1, wherein:
said attachment portions of said first and second attachment flanges include oppositely tapered marginal surfaces; and
said fastener comprises a band clamp having oppositely tapered flange portions thereof which mate with the tapered marginal surfaces of said attachment portions of said first and second connector flanges, such that constriction of said band clamp draws said first and second connector flanges closely together to create said airtight seal between said inlet tube and said housing.

17. An exhaust pulse control unit as set forth in claim 1, including:
a first weld extending between and around said inlet tube and said second connector flange to define an airtight seal therebetween.

18. An exhaust pulse control unit as set forth in claim 1, including:
a second weld extending between and around said housing and said first connector flange to define an airtight seal therebetween.

19. An exhaust pulse control unit as set forth in claim 1, including:
a third connector flange having a radially outwardly extending attachment portion, and a central aperture therethrough which is axially aligned with said housing at an end thereof opposite said first connector flange; said connector flange being operably connected with said housing; and
a fourth connector flange having a radially outwardly extending attachment portion which is axially aligned with said attachment portion of said third connector flange, and a central aperture therethrough which is axially aligned with said outlet tube, and includes an inlet portion and an oppositely disposed outlet portion; said fourth connector flange being operably connected with said outlet tube adjacent said inlet portion thereof; said inlet portion of said central aperture of said fourth connector flange having a beveled surface formed integrally therein to define a merger zone between said housing and said outlet tube.

20. A method for making an exhaust pulse control unit for internal combustion engines, comprising:
forming an inlet tube into a shape configured for communication with incoming exhaust gas;
forming an outlet tube into a shape configured for communication with exiting exhaust gas;
forming a housing shaped to extend between the inlet tube and the outlet tube;
operably connecting the inlet tube to one end of the housing and the outlet tube to the opposite end of the housing;
forming an intermediate zone along a medial portion of the housing;
forming a first connector flange having a radially outwardly extending attachment portion, and a central aperture therethrough;
axially aligning the central aperture of the first connector flange with the housing;
operably connecting the first connector flange with the housing;
forming a second connector flange having a radially outwardly extending attachment portion, and a central aperture therethrough which includes an inlet portion and an oppositely disposed outlet portion;
axially aligning the central aperture of the second connector flange with the inlet tube, such that the attachment portions of the first and second connector flanges are axially aligned;
operably connecting the second connector flange with the inlet tube adjacent the inlet portion thereof;
integrally forming at least one beveled surface in the outlet portion of the central aperture of the second connector flange to define a nozzle which forms at least one pulse capture and expansion zone configured to increase exhaust manifold vacuum in an associated internal combustion engine; and
detachably, yet securely, fastening the attachment portion of the first connector flange with the attachment portion of the second connector flange to form an airtight seal between the inlet tube and the housing.

21. A method as set forth in claim 20, including:
forming a second beveled surface integrally in the outlet portion of the central aperture of said second connector flange to increase exhaust manifold vacuum in the associated internal combustion engine.

22. A method as set forth in claim 21, wherein:
said first beveled surface forming step comprises forming the first beveled surface at an angle different from the angle of the second beveled surface.

23. A method as set forth in claim 22, wherein:
said second beveled surface forming step comprises forming the second beveled surface adjoining the first beveled surface.

24. A method as set forth in claim 23, wherein:
said second beveled surface forming step comprises forming the second beveled surface at an angle greater than the angle of the first beveled surface.

25. A method as set forth in claim 24, wherein:
said second connector flange forming step comprises forming the second connector flange from hardened steel, and precisely grinding the first and second beveled surfaces therein.

26. A method as set forth in claim 25, wherein:
said fastening step comprises positioning a plurality of threaded fasteners in mating axially extending fastener apertures in the attachment portions of the first and second attachment flanges, and tightening the threaded fasteners to draw the first and second connector flanges closely together to create the airtight seal between the inlet tube and the housing.

27. A method as set forth in claim 25, wherein:
said second connector flange forming step includes forming a generally L-shaped annular step therein adjacent to the housing; and
said first connector flange forming step includes forming a generally L-shaped annular ring portion therein adjacent to the inlet tube, and positioning the ring portion in the annular step in the second connector flange.

28. A method as set forth in claim 25, wherein:
said fastening step includes forming oppositely tapered marginal surfaces in the attachment portions of the first and second attachment flanges; and
providing a band clamp having oppositely tapered flange portions, and positioning the same over the tapered marginal surfaces of the attachment portions of the first and second connector flanges, such that constriction of the band clamp draws the first and second connector flanges closely together to create the airtight seal between the inlet tube and the housing.

29. A method as set forth in claim 26, including:
forming a first weld between and around the inlet tube and the second connector flange to define an airtight seal therebetween.

30. A method as set forth in claim 29, including:
forming a second weld between and around the housing and the first connector flange to define an airtight seal therebetween.

31. A method as set forth in claim 30, including:
forming a third connector flange having a radially outwardly extending attachment portion and a central aperture therethrough;
axially aligning the central aperture of the third connector flange with the housing at an end thereof opposite the first connector flange;
operably connecting the third connector flange with the housing;
forming a fourth connector flange having a radially outwardly extending attachment portion, and a central aperture therethrough which includes an inlet portion and an oppositely disposed outlet portion;
axially aligning the central aperture of the fourth connector flange with the outlet tube, such that the attachment portions of the third and fourth connector flanges are axially aligned;
operably connecting the fourth connector flange with the outlet tube adjacent the outlet portion thereof;
integrally forming at least one beveled surface in the inlet portion of the central aperture of the fourth connector flange to define a nozzle which forms at least one merger zone configured to increase exhaust manifold vacuum in an associated internal combustion engine; and
detachably, yet securely, fastening the attachment portion of the third connector flange with the attachment portion of the fourth connector flange to form an airtight seal between the outlet tube and housing.
